(19) United States
(12) Patent Application Publication
(10) Pub. No.: US 2019/0216047 A1
(43) Pub. Date: Jul. 18, 2019

(54) Foldable Pet Bed

(71) Applicant: Spruce Group Limited Liability Company, Natrona Heights, PA (US)

(72) Inventors: Elijah Wiegmann, Natrona Heights, PA (US); Patrick Brady, Allison Park, PA (US)

(21) Appl. No.: 16/242,737

(22) Filed: Jan. 8, 2019

Related U.S. Application Data
(60) Provisional application No. 62/614,524, filed on Jan. 8, 2018.

(51) Int. Cl. A01K 1/035

(52) U.S. Cl. CPC A01K 1/0353

(57) ABSTRACT

A bed foldable between an open position and a closed position includes a case having a first side and a second side. Each side has at least one sidewall defining a bedding receptacle. The sidewall of the first side and the sidewall of the second side are connected via a hinge having a hinge axis located at a position between the sidewall of the first side and the sidewall of the second side. In the open position, an outer surface of the sidewall of the first side faces an outer surface of the sidewall of the second side. The bed further includes a mattress assembly having a top surface and two downwardly extending cushions, each of the two downwardly extending cushions shaped to correspond to the bedding receptacle of one of the first side and the second side of the case.

### CROSS-REFERENCE TO RELATED APPLICATION

This application claims priority to U.S. Provisional Patent Application No. 62/614,524, filed on Jan. 8, 2018 and entitled “Foldable Pet Bed”, the disclosure of which is hereby incorporated by reference in its entirety.

### BACKGROUND OF THE INVENTION

### Field of the Invention

This invention relates to pet beds, and, in particular, portable pet beds.

### Description of Related Art

Pet beds typically take the form of pillowcase-like fabrics filled with material that is uncomfortable and often lumpy. Such beds are also not easily transportable, as they are not compact, are typically shaped in odd ways, and do not include features such that a pet owner could easily grasp them. Some pet beds that are foldable are known, such as U.S. Pat. Nos. 4,198,718 and 6,907,842. However there exists a need for a comfortable pet bed that is easily transportable, compact, and provides pet owners with additional conveniences to make pet travel easier.

### SUMMARY OF THE INVENTION

The present disclosure includes a foldable pet bed that may be rugged, warm, washable, and waterproof. As shown, it may include a case defining two chambers or receptacles configured to receive a mattress assembly, and that is foldable between the two chambers. The mattress assembly may also include cushiony bolsters. The mattress assembly and case are both foldable into an enclosed container or bag. The case may include a zipper around its periphery to fully close the container. The closed container may contain all the fur, smells, drool, and other pet messes during travel without spreading the mess to the car or elsewhere. Handles and leash clips may be included to hook a pet's leash as well so that there is one less item to carry. Also, pockets, such as elastic pockets, may be provided on the case so as provide a place to store bags or treats.

Non-limiting embodiments of the present invention are directed to a bed foldable between an open position and a closed position. The bed includes a case having a first side and a second side, each side having at least one sidewall defining a bedding receptacle. The sidewall of the first side and the sidewall of the second side are connected via a hinge having a hinge axis located at a position between the sidewall of the first side and the sidewall of the second side, such that, in the open position, an outer surface of the sidewall of the first side faces an outer surface of the sidewall of the second side. The bed further includes a mattress assembly having a top surface and two downwardly extending cushions, each of the two downwardly extending cushions shaped to correspond to the bedding receptacle of one of the first side and the second side of the case. In the open position, each of the two downwardly extending cushions is positioned in one of the bedding receptacles of the case with the mattress top surface facing outward and away from the case. In the closed position, the case is folded along the hinge axis such that the mattress assembly is folded into an interior of the case.

In some non-limiting embodiments, in the open position, the hinge axis is located proximate to a top of the sidewall of the first side of the case and proximate to a top of the sidewall of the second side of the case.

In some non-limiting embodiments, the mattress assembly includes a mattress cover having two sleeves on an underside thereof, each of the two sleeves configured to receive one of the two downwardly extending cushions.

In some non-limiting embodiments, the mattress assembly defines a seam coaxial with the hinge axis such that the mattress assembly may be folded about the seam and the hinge axis.

In some non-limiting embodiments, the mattress assembly includes a padded bolster positioned on a periphery of the top surface of the mattress assembly.

In some non-limiting embodiments, the mattress cover includes a padded bolster positioned on a periphery of the top surface of the mattress assembly.

In some non-limiting embodiments, in the closed position, the sidewall of the first side of the case, the sidewall of the second side of the case, and the top surface of the mattress assembly define an interior volume therebetween.

In some non-limiting embodiments, the bed further includes a zipper extending at least partially around a periphery of the sidewalls of the first side and the second side of the case. A portion of the zipper disposed on the first side of the case is configured to mate with a portion of the zipper disposed on the second side of the case to secure the first side of the case to the second side of the case in the closed position.

In some non-limiting embodiments, the bed further includes at least one fastener for connecting the mattress assembly to the case.

In some non-limiting embodiments, the hinge of the case includes a first portion connected to the sidewall of the first side of the case, a second portion connected to the sidewall of the second side of the case, and a flexible portion defining the hinge axis between the first portion and the second portion.

In some non-limiting embodiments, the first portion of the hinge is connected to an outer face of the sidewall of the first side of the case, and the second portion of the hinge is connected to an outer face of the sidewall of the second side of the case.

In some non-limiting embodiments, the hinge includes a flexible fabric.

In some non-limiting embodiments, in the open position, the first portion of the hinge defines an acute angle relative to the second portion of the hinge.

In some non-limiting embodiments, the bed further includes a handle connected to at least one of the first side of the case and the second side of the case.

In some non-limiting embodiments, the handle is located on a portion of the case opposite the hinge in the closed position.

Other non-limiting embodiments of the present invention are directed to a case for a bed foldable between an open position and a closed position. The case includes a first side and a second side, each side having at least one sidewall defining a bedding receptacle. The sidewall of the first side and the sidewall of the second side are connected via a hinge having a hinge axis located at a position between the sidewall of the first side and the sidewall of the second side, such that, in the open position, an outer surface of the sidewall of the first side faces an outer surface of the sidewall of the second side. In the open position, each of the bedding receptacles is opened facing upward and away from the case, and, in the closed position, the case is folded along the hinge axis such that the sidewalls of the first side and the second side are aligned.

In some non-limiting embodiments, in the open position, the hinge axis is located proximate to a top of the sidewall of the first side and proximate to a top of the sidewall of the second side.

In some non-limiting embodiments, the hinge includes a first portion connected to the sidewall of the first side, a second portion connected to the sidewall of the second side, and a flexible portion defining the hinge axis between the first portion and the second portion.

In some non-limiting embodiments, the first portion of the hinge is connected to an outer face of the sidewall of the first side; and the second portion of the hinge is connected to an outer face of the sidewall of the second side.

In some non-limiting embodiments, the hinge includes a flexible fabric. These and other features and characteristics of the present invention, as well as the methods of operation and functions of the related elements of structures and the combination of parts and economies of manufacture, will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular forms of “a”, “an”, and “the” include plural referents unless the context clearly dictates otherwise.

### BRIEF DESCRIPTION OF THE DRAWINGS

FIG. 1 is a perspective view of a portable pet bed according to a non-limiting embodiment of the present invention, shown in an open position;

FIG. 2 is a top view of the portable pet bed of FIG. 1;

FIG. 3 is a side view of the portable pet bed of FIG. 1;

FIG. 4 is a perspective view of a case of the foldable pet bed of FIG. 1;

FIG. 5 is a side view of the case of FIG. 4;

FIG. 6 is a perspective view of the hinge of the case of FIG. 4;

FIG. 7 is an exploded perspective view of the portable pet bed of FIG. 1;

FIG. 8 is an exploded perspective view of the portable pet bed of FIG. 1;

FIG. 9 is an exploded side perspective view of the portable pet bed of FIG. 1;

FIG. 10 is a perspective view of the portable pet bed of FIG. 1, shown in a closed position;

FIG. 11 is a front view of the portable pet bed of FIG. 10;

FIG. 12 is a side view of the portable pet bed of FIG. 10;

FIG. 13 is a side cross-sectional view of the hinge of the case of FIG. 10;

FIG. 14 is a perspective cross-sectional view of the hinge of the case of FIG. 10;

FIG. 15 is a perspective view of a portable pet bed according to a non-limiting embodiment of the present invention, shown in an open position;

FIG. 16 is a top view of the portable pet bed of FIG. 15;

FIG. 17 is a bottom view of the portable pet bed of FIG. 15;

FIG. 18 is a front view of the portable pet bed of FIG. 15;

FIG. 19 is side view of the portable pet bed of FIG. 15;

FIG. 20 is an exploded perspective view of the portable pet bed of FIG. 15;

FIG. 21 is a perspective view of the portable pet bed of FIG. 15, shown a closed position;

FIG. 22 is a side view of the portable pet bed of FIG. 21; and

FIG. 23 is a bottom view of the portable pet bed of FIG. 21.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings and described in the following specification are simply exemplary embodiments or aspects of the invention. Hence, specific dimensions and other physical characteristics related to the embodiments or aspects disclosed herein are not to be considered as limiting.

As used herein, the term “at least one of” is synonymous with “one or more of”. For example, the phrase “at least one of A, B, and C” means any one of A, B, and C, or any combination of any two or more of A, B, and C. For example, “at least one of A, B, and C” includes one or more of A alone; or one or more B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of”. For example, the phrase “at least two of D, E, and F” means any combination of any two or more of D, E, and F. For example, “at least two of D, E, and F” includes one or more of D and one or more of E; or one or more of D and one or more of F; or one or more of E and one or more of F; or one or more of all of D, E, and F.

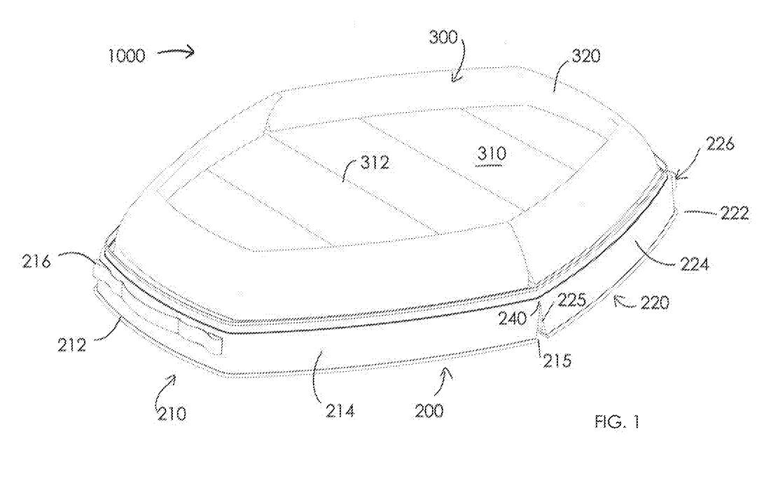

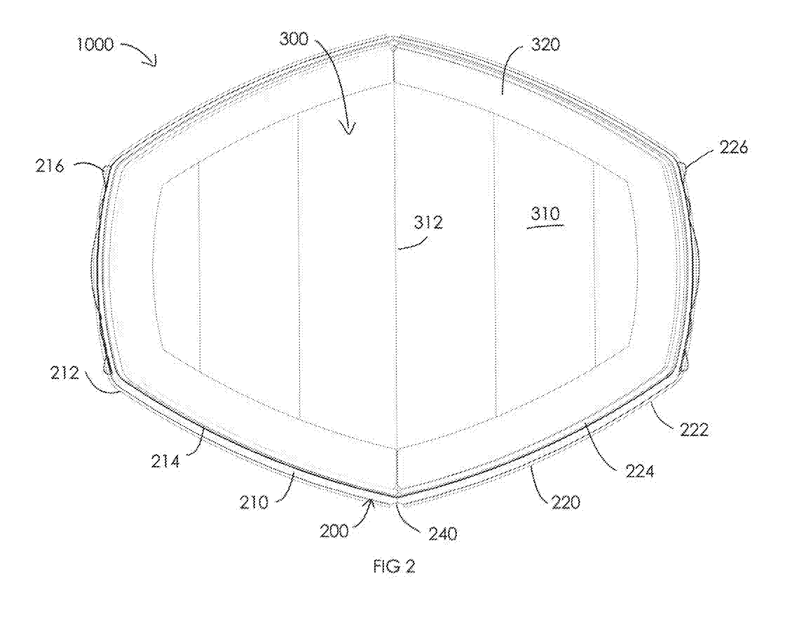

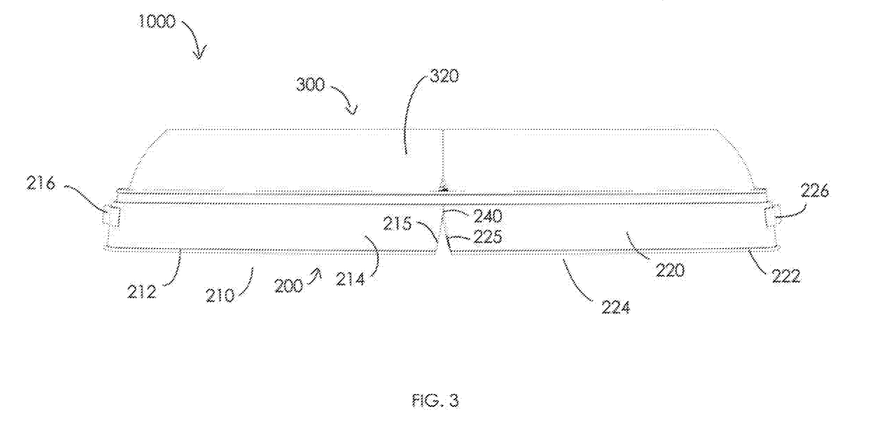

Embodiments of the present invention are generally directed to a bed, particularly suitable for pets, that is foldable between an open position and a closed position. Referring now to FIGS. 1-3, a bed 1000 according to a non-limiting embodiment of the present invention generally includes a case 200 and a mattress assembly 300 at least partially housed within the case 200. The case 200 may be divided into a first side 210 and a second side 220 joined to each other by a hinge 240. The first side 210 of the case 200 may include a bottom wall 212 and at least one sidewall 214 extending upward from the bottom wall 212. At least a portion of the mattress system 300 fits into a cavity defined by the bottom wall 212 and the sidewall 214. The second side 220 of the case 200 may be substantially similar to the first side 210, in that the second side 220 may include a bottom wall 222 and at least one sidewall 224 extending upward from the bottom wall 212. At least a portion of the mattress system 300 fits into a cavity defined by the bottom wall 222 and the sidewall 224. In the open position of the bed 1000 shown in FIGS. 1-3, the bottom walls 212, 222 may be arranged to lie flat on the ground or other surface such that the bottom walls 212, 222 are substantially coplanar with each other. The bottom walls 212, 222 and the sidewalls 214, 224 of the case 200 may be constructed from a fabric material such that the case 200 is deformable, insulating, and easy to clean. Suitable materials for construction of the bottom walls 212, 222 and the sidewalls 214, 242 include, but are not limited to, polyester, cotton, fleece, denim, canvas, structural mesh, etc., depending upon the intended application and operating environment of the bed 1000.

With continued reference to FIGS. 1-3, the mattress system 300 may include a top surface 310 configured for a pet to rest on. The top surface 310 may be soft, padded, quilted, and/or otherwise deformable to maximize comfort of a pet resting on the top surface 310. In some non-limiting embodiments, the mattress system 300 may further include a bolster 320 extending upward from the top surface 310 and at least partially around the periphery of the mattress system 300. Like the top surface 310, the bolster 320 may be soft, padded, quilted, and/or otherwise deformable to maximize comfort of the pet. A seam 312 extends transversely across the top surface 310 and rests approximately adjacent to the hinge 240 of the case 200. The seam 312 may be located substantially adjacent with the hinge 240 of the case 200. As such, the seam 312 permits the mattress system 300 to bend as the case 200 folds about the hinge 240.

In some non-limiting embodiments, each of the first side 210 and the second side 220 of the case 200 may further include a handle 216 to facilitate carrying and positioning of the bed 1000. Other features for improving the functionality of the bed 1000, such as storage pockets, leash clips, and other accessories may also be provided on the case 200.

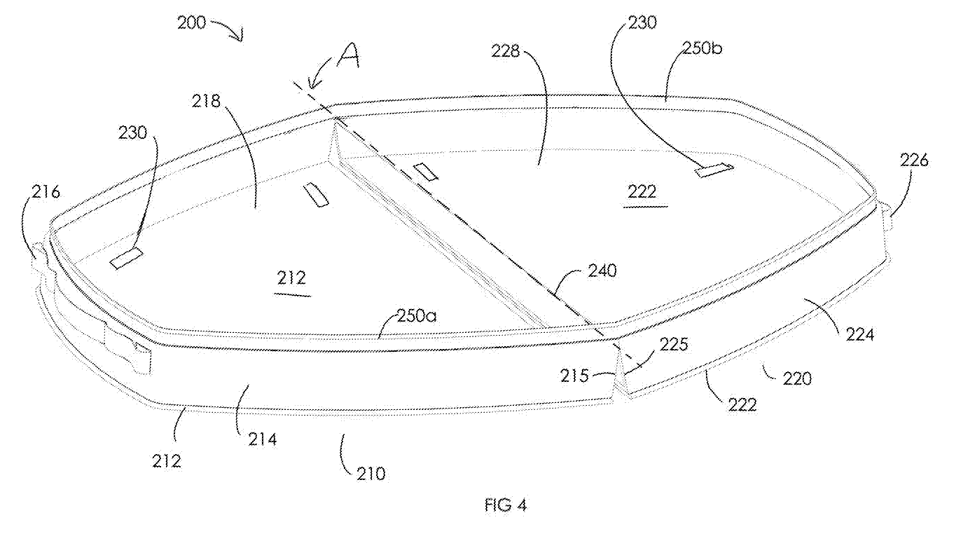

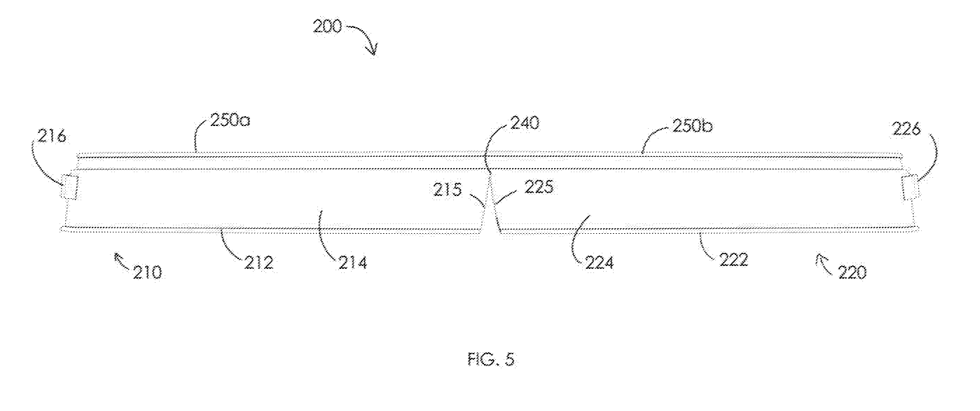

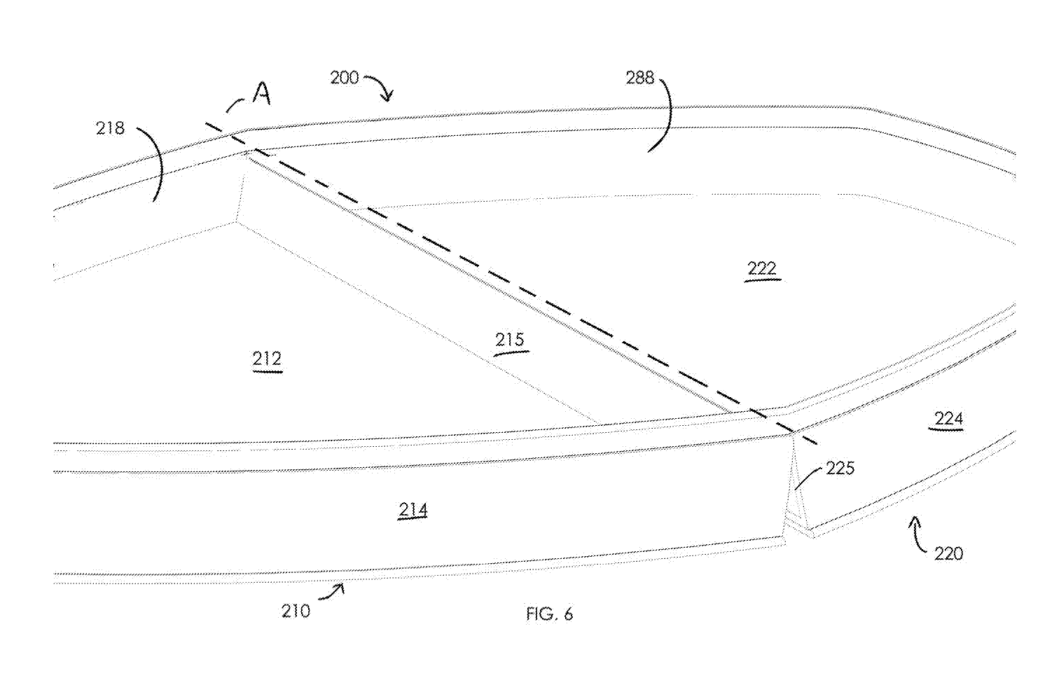

Referring now to FIGS. 4-6, the case 200 is shown with the mattress assembly 300 removed to illustrate interior features of the case 200. As noted above, the bottom wall 212 and the at least one sidewall 214 of the first side 210 of the case 200 define a cavity in which at least a portion of the mattress system 300 sits. In particular, the bottom wall 212 and the at least one sidewall 214 define a bedding receptacle 218 having an open upper face such that a portion of the mattress system 300 may be lowered into the first side 210 of the case 200. The mattress system 300 is thus restrained from downward motion and lateral motion by the bottom wall 212 and the sidewall 214, respectively. Similarly, the bottom wall 222 and the at least one sidewall 224 of the second side 220 of the case 200 define a bedding receptacle 228 having an open upper face such that a portion of the mattress system 300 may be lowered into the second side 220 of the case 200. The bottom wall 212 and the sidewall 224 prevent downward motion and lateral motion, respectively, of the mattress system 300 within the second side 220 of the case 200.

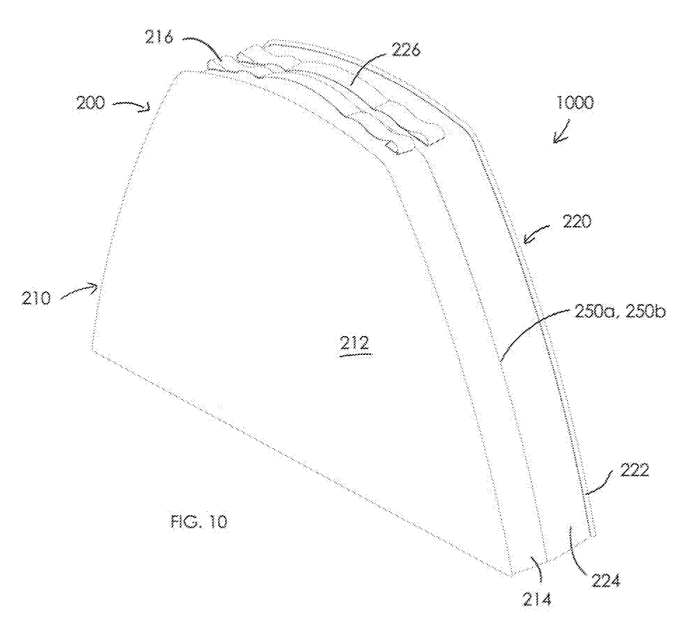

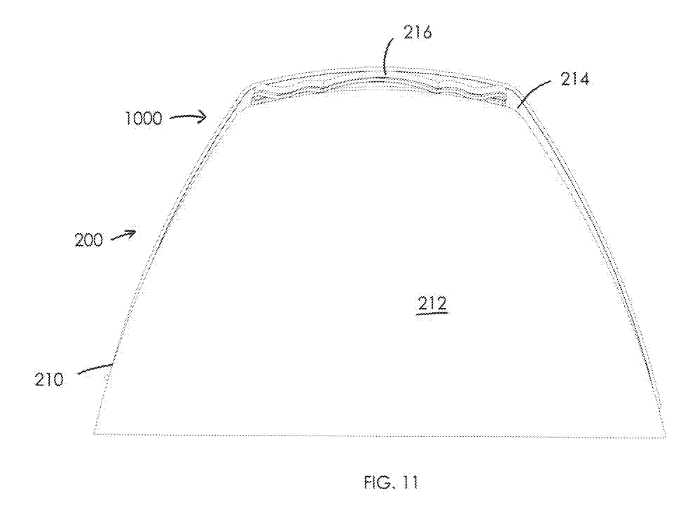

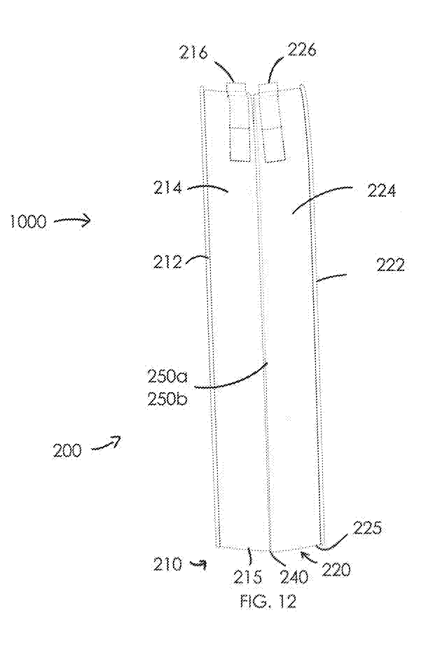

As noted above, the first side 210 and the second side 220 of the case 200 are connected via a hinge 240. The hinge 240 may be mounted to a base portion 215 of the sidewall 214 of the first side 210 and to a base portion 225 of the sidewall 224 of the second side 220. The hinge 240 permits rotation of the first side 210 relative to the second side 220 of the case about a hinge axis A. Generally, the hinge axis A extends parallel to the bottom walls 212, 222 of the first side 210 and the second side 220 of the case 200. The hinge axis A bisects the case 200 such that the first side 210 and the second side 220 may be folded together such that their respective sidewalls 214, 224 are substantially aligned (as will be described in greater detail hereinafter with reference to FIGS. 10-12).

In some non-limiting embodiments, the first side 210 and/or the second side 220 of the case 200 may include one or more fasteners 230 for further securing the mattress system 300 to the case 200. Suitable fasteners 230 include hook-and-loop fasteners (e.g. VELCRO®), snaps, buttons, zippers, or like elements. Generally, the fasteners 230 may be elements which are readily detachable to facilitate easy installation and removal of the mattress system 300 into the case 200. The fasteners 230 are configured to mate with corresponding fasteners (not shown) on the mattress system 300. The fasteners 230 may be located at any location on the first side 210 and/or the second side 220 of the case 200 that provides a suitable attachment point for the mattress system 300.

In some non-limiting embodiments, the case 200 may include a zipper 250a, 250b extending at least partially around the peripheries of the first side 210 and the second side 220 and attached to the sidewalls 214, 224 thereof. A first zipper portion 250a may be attached to the first side 210 of the case 200, and a second zipper portion 250b may be attached to the second side 220 of the case 200. A zipper pull tab, as is generally known in the art, may be used to draw the first and second zipper portions 250a, 250b toward each other and into a mated engagement. Consequently, engagement of the zipper portions 250a, 250b to each other brings the bed 1000 from the open position shown in FIGS. 1-6 to the closed position shown in FIGS. 10-12. Other fastening elements such as buttons, snaps, hook-and-loop fasteners, clips, or the like may be used in addition to or in place of the zipper 250a, 250b to transition and hold the bed 1000 in the closed position.

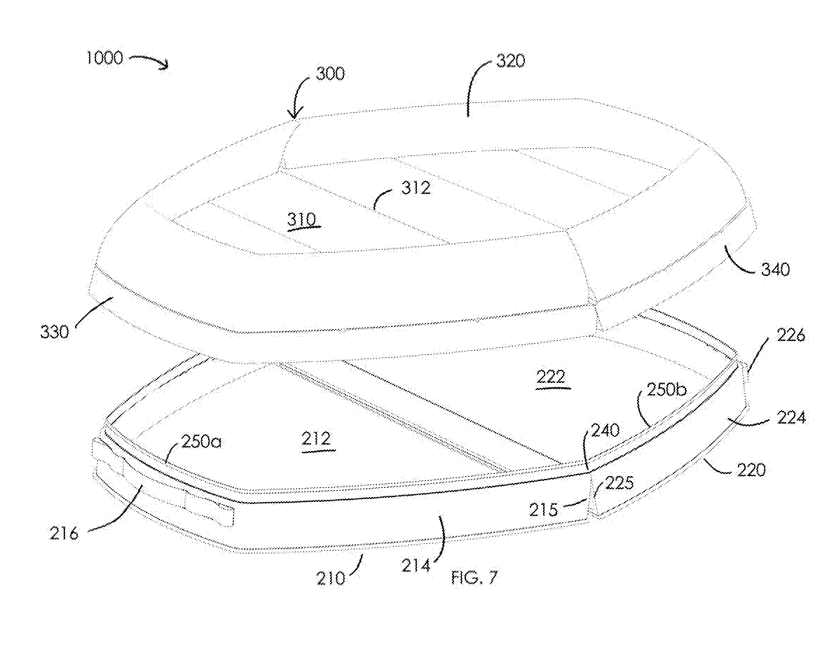

Referring now to FIGS. 7-9, various exploded views of the bed 1000 in accordance with non-limiting embodiments of the present invention are shown to illustrate the fitment of the mattress assembly 300 into the case 200. Referring first to FIG. 7, the mattress assembly 300 may include two cushions 330, 340 extending downward from the top surface 310. Each of the cushions 330, 340 is configured to fit within one of the bedding receptacles 218, 228 defined in the first side 210 and the second side 220 of the case 200. The cushions 330, 340 may be connected to each other via the seam 312 of the top surface 310. The cushions may constructed of a padded, shock-absorbent material such as foam (e.g. memory foam), down, batting, or like material.

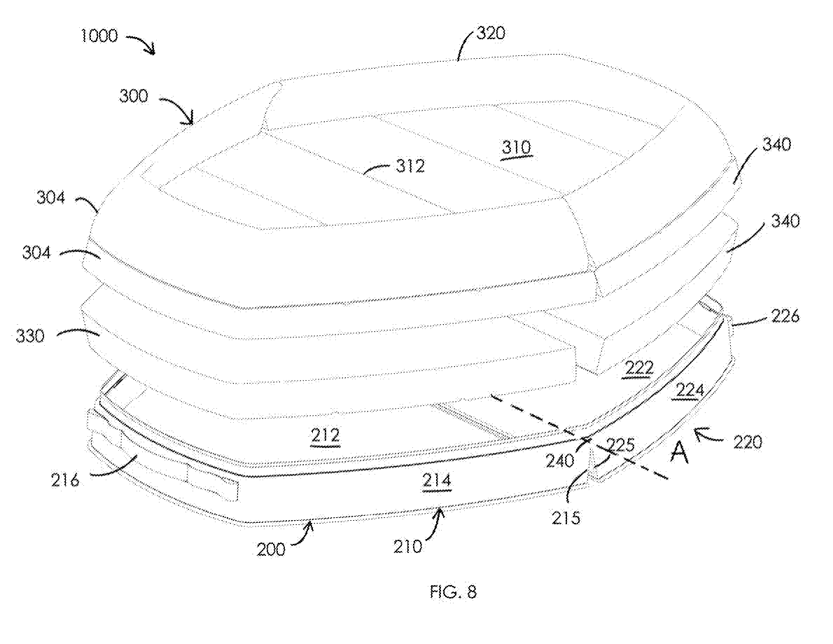

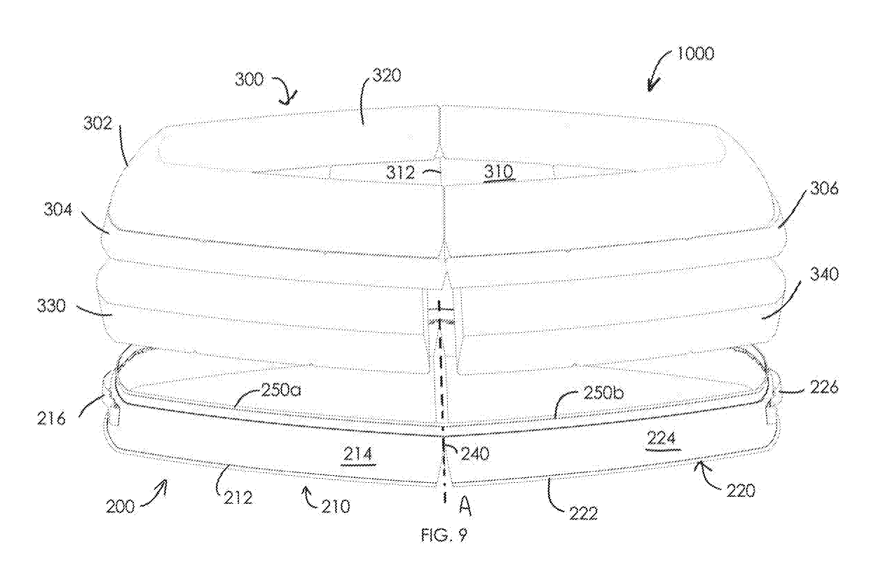

Referring now to FIGS. 8-9, the top surface 310 and the bolster 320 may be part of a mattress cover 302 which is separable from the cushions 330, 340. The mattress cover 302 may further include sleeves 304, 306, each extending downward from the top surface 310 and configured to receive one of the cushions 330, 340 therein. The sleeves 304, 306 may define an opening for insertion and removal of the cushions 330, 340. As such, the cushions 330, 340 may be removed from the mattress cover 302 so that the mattress cover 302 may be cleaned apart from the cushions 330, 340. The mattress cover 302 may be made from a fabric material such as polyester, cotton, fleece, denim, canvas, structural mesh, etc., depending upon the intended application and operating environment of the bed 1000.

With continued reference to FIGS. 7-9, and as noted above, the seam 312 of the top surface 312 of the mattress system 300 may be positioned to align substantially with the hinge 240, and particularly the hinge axis A, of the case 200. As such, rotation of the first side 210 and/or the second side 220 of the case about the hinge axis A causes rotation of the mattress system 300 about the seam 312. Thus, if the first side 210 of the case 200 is rotated about the hinge axis A relative to the second side 220 of the case 200, the cushion 330 inserted in the first side 210 rotates in a corresponding manner relative to the cushion 340 inserted in the second side 220. Accordingly, the case 200 and the mattress system 300 may be folded and unfolded about the hinge axis A as a unitary structure. It is noted that the seam 312 may be a physical structure, such as stitching, of the mattress system 300. Alternatively, the seam 312 may be a location continuous with the adjacent portion of the mattress system 300 where the mattress system 300 is configured to bend.

Referring now to FIGS. 10-12, the bed 1000 is shown in a folded position, particularly suitable for transportation and storage thereof. The mattress system 300 may be substantially encapsulated by the case 200 and substantially hidden from view. In particular, the sidewall 214 of the first side 210 of the case 200 is aligned with and brought into engagement with the sidewall 224 of the second side 220 of the case 200 via the zipper 250a, 250b (or other suitable fastening element). The mattress system 300 is contained within the interior volume of the case 200 defined by the bottom walls 212, 222 and the sidewalls 214, 224. The interior volume of the case 200 may also include an area unoccupied by the mattress system 300 which may be used as storage for items such as pet toys, food, supplies, etc. Further, in the closed position, the bed 1000 container interior volume of the case 200 may isolate the fur, smells, drool, and other pet messes made on the mattress system 300 from the outside environment. Thus, the bed 1000 may be used for travel without spreading any messes made on the mattress system 300 to a user, a car, or elsewhere.

In the closed position, the bed 1000 may be freestanding by resting on the base portions 215, 225 of the sidewalls 214, 224 adjacent the hinge 240 on the ground or other flat surface. The handles 216, 226 of the case 200 may be arranged such that, in the closed position, the handles 216, 226 are directed substantially upward to facilitate ergonomic carrying of the bed 1000.

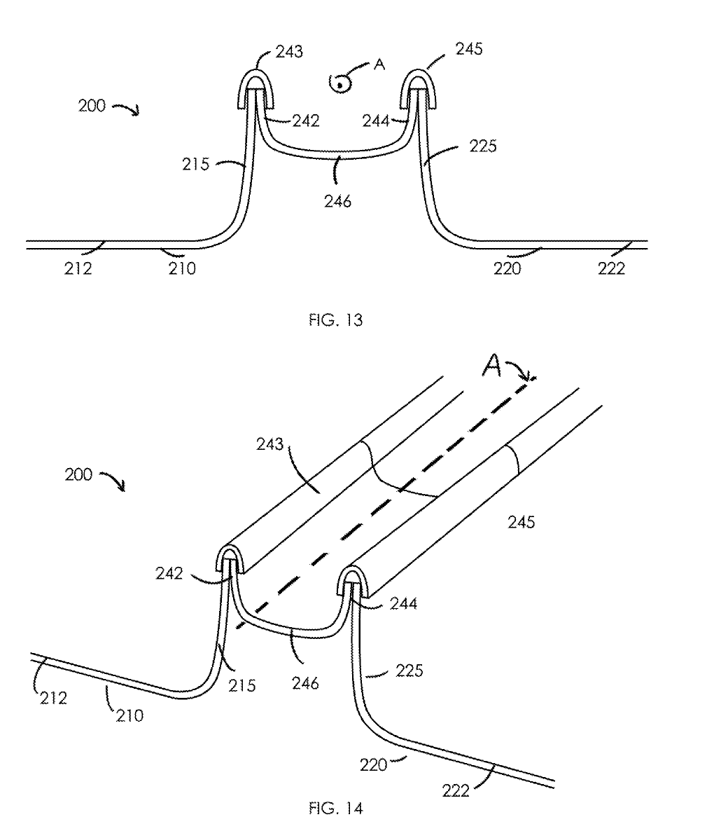

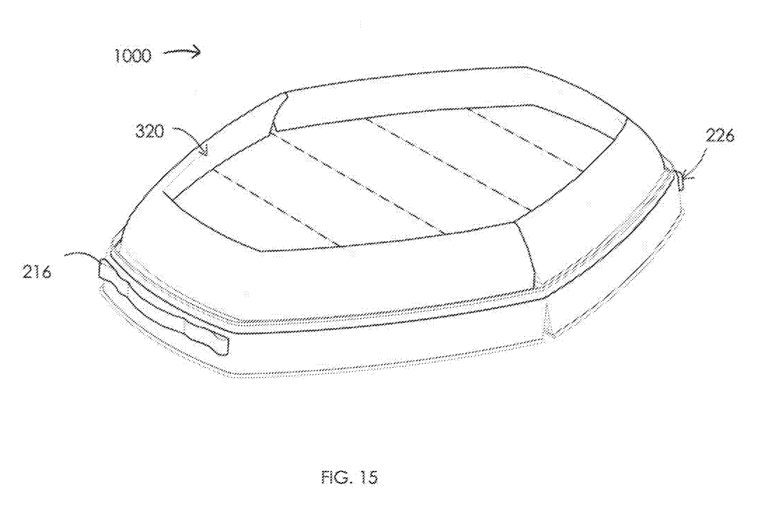

Referring now to FIGS. 13-14, details of the hinge 240 of the case 200 are shown with the bed 1000 in the open position. The base portions 215, 225 of the sidewalls 214, 224 of the first side 210 and the second side 220 of the case 200 are substantially vertical and therefore define an acute angle β relative to each other in the open position. Additionally, outer surfaces of the base portions 215, 225 of the respective sidewalls 214, 224 face each other in the open position. The hinge 240 may include a first portion 242 attached to the base portion 215 of the first side 210, and a second potion 244 attached to the base portion 225 of the second side 220. A flexible portion 246 may extend between the first portion 242 and the second portion 244 and define the hinge axis A. More particularly, an end of the first portion 242 may be attached to a top edge of the base portion 215 of the first side 210 and extend along a face of the base portion 215. Similarly, an end of the second portion 244 may be attached to a top edge of the base portion 225 of the second side 220 and extend along a face of the base portion 225. Opposite ends of the first and second portions 242, 244 may separate from the respective base portions 215, 225 and join at the flexible portion 246. The flexible portion 246 permits folding of the hinge 240 about the hinge axis A, which may extend between the first and second portions 242, 244 of the hinge 240. More particularly, the hinge axis A may be located proximate to a top edge of the sidewall 214 of the first side 210 of the case 200 and proximate to a top edge of the sidewall 224 of the second side 220 of the case 200. The first portion 242, the second portion 244, and the flexible portion 246 of the hinge 240 may be a continuous piece of fabric or other bendable material capable of folding about the hinge axis A. The hinge 240 may be made from the same material as the first side 210 and second side 220 of the case 200. Caps 243, 245 may be attached over the first and second portions 242, 244 and their respective base portions 215, 225 to reinforce the connection between the hinge 240 and the first and second sides 210, 220 of the case 200. The caps 243, 245 may be made of the same material, such as a fabric, as the other components of the hinge 240 and/or the case 200.

As noted herein, many of the components of beds 1000 according to non-limiting embodiments of the present invention may be made from various fabrics. The fabric components may be attached to one another, where applicable, using various types of stitching as known in the art. As such, the scope of the present invention is not to be construed as limited by various sewing methods or types of stitching alluded to herein. Rather, any specific methods of connection and assembly of the beds 1000 described herein are merely exemplary and non-limiting.

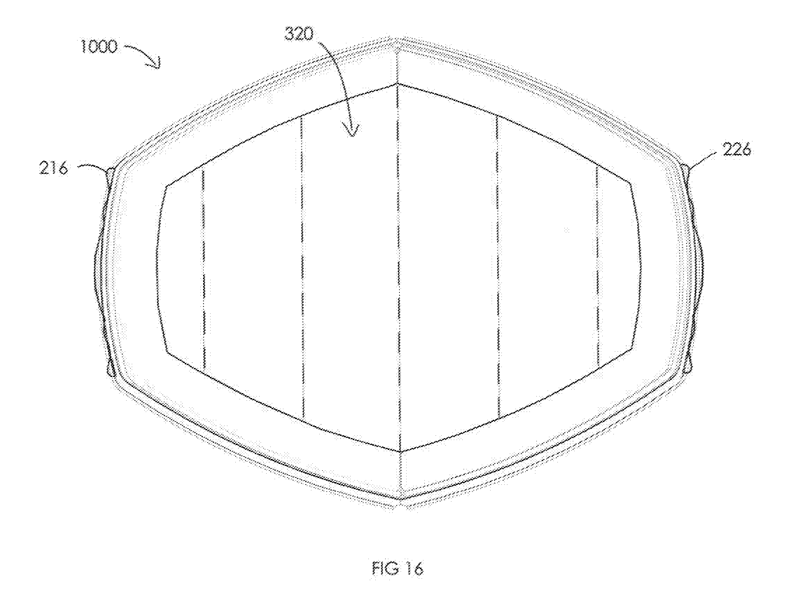

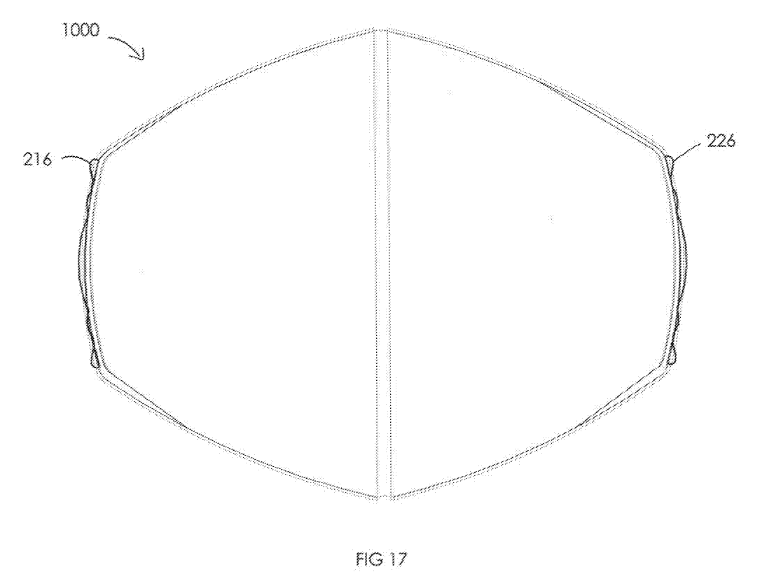

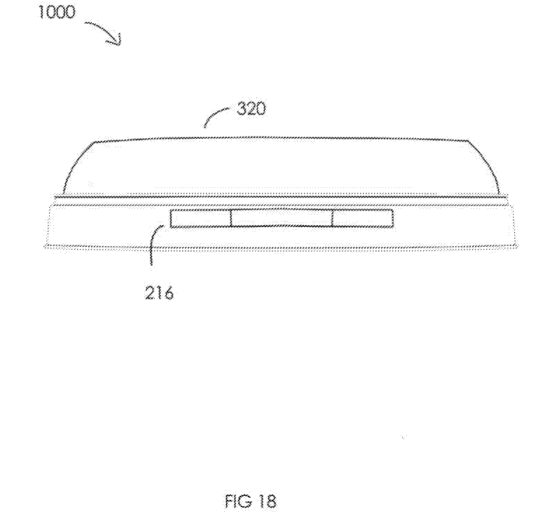

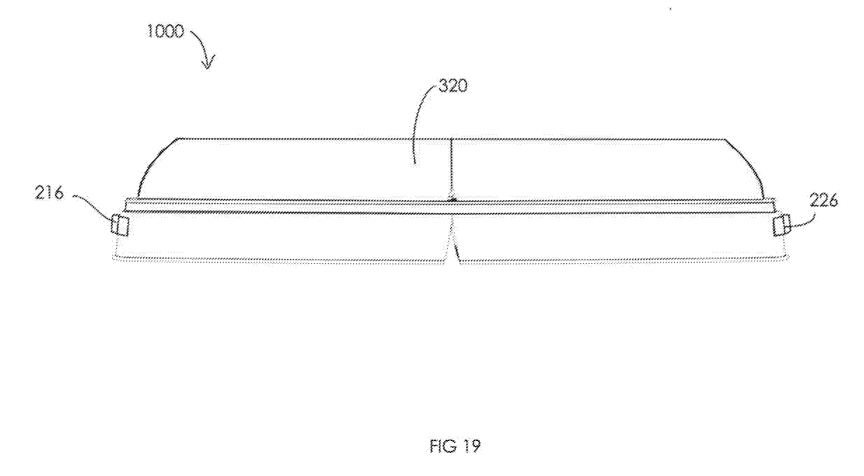

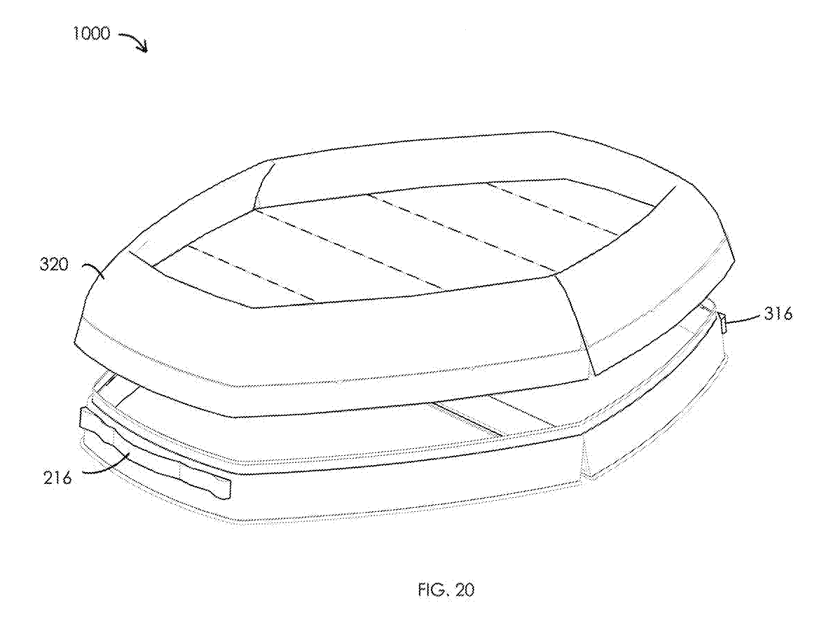

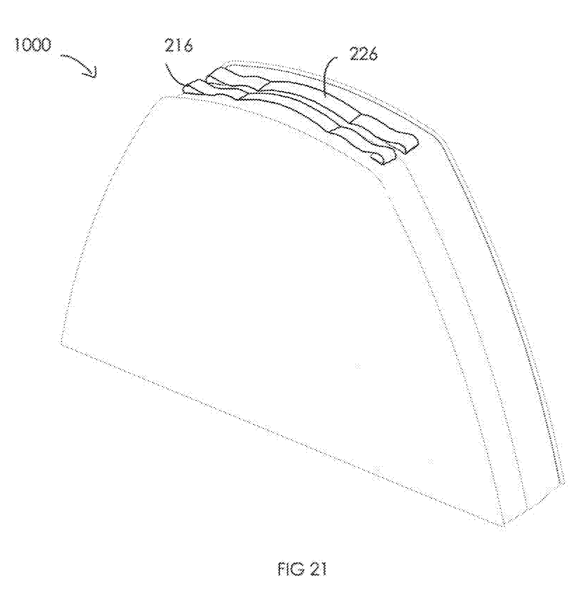

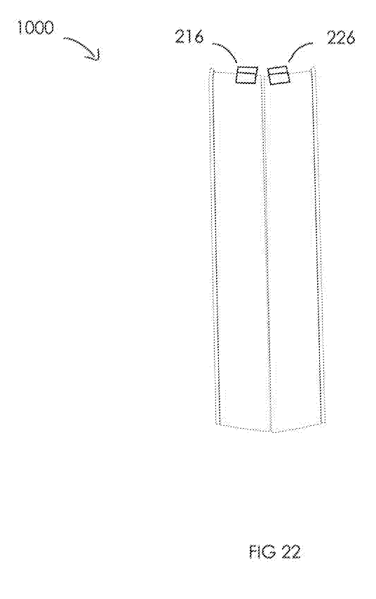

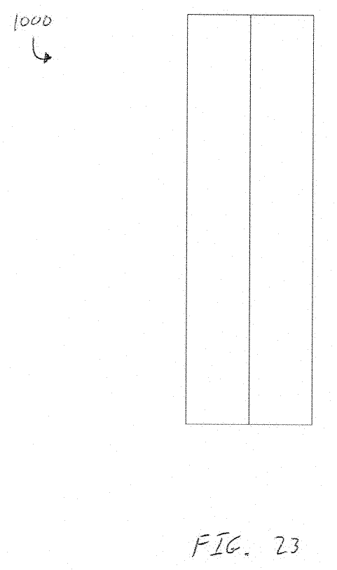

FIGS. 15-23 illustrate another non-limiting embodiment of a bed 1000 according to the present invention. The thick dashed lines indicate features which may be absent, or may assume different angles and shapes, in non-limiting embodiments of the present invention. For example, the handles 216, 226 and the bolster 320 of the bed 1000 may be omitted or assume different shapes and angles in non-limiting embodiments of the present invention.

Other non-limiting embodiments of the present invention are directed to method of folding and unfolding the bed 1000 described above. Starting from the open position shown in FIGS. 1-9, the bed 1000 may be folded into the closed position of FIGS. 10-12 by bringing ends of the first side 210 and the second side 220 of the case 200 opposite the hinge 240 toward each other. That is, the first side 210 is rotated relative to the second side 220, or vice versa, about the hinge axis A. The handles 216, 226 may be used for this purpose, or the first and/or second sides 210, 220 may be gripped in any suitable location to achieve the required movement. With the first and second sides 210, 220 brought together such that the respective sidewalls 214, 224 are substantially aligned, the zipper 250a, 250b (or other suitable fastening device) may be used to secure the first and second sides 210, 220 together. Unfolding the bed 1000 back to the open position is simply the reverse of the foregoing method of closure. The weight of the components of the bed 1000 may assist a user in unfolding the first and second sides 210, 220 of the case 200 about the hinge axis A.

It is to be understood that the invention may assume various alternative variations and step sequences, except where expressly specified to the contrary. It is also to be understood that the specific devices and processes illustrated in the attached drawings and described in the specification are simply exemplary embodiments or aspects of the invention. Although the invention has been described in detail for the purpose of illustration based on what are currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that to the extent possible, one or more features of any embodiment or aspect can be combined with one or more features of any other embodiment or aspect.

The invention claimed is:

1. A bed foldable between an open position and a closed position, comprising:
a case having a first side and a second side, each side having at least one sidewall defining a bedding receptacle, wherein the sidewall of the first side and the sidewall of the second side are connected via a hinge having a hinge axis located at a position between the sidewall of the first side and the sidewall of the second side, such that, in the open position, an outer surface of the sidewall of the first side faces an outer surface of the sidewall of the second side; and
a mattress assembly having a top surface and two downwardly extending cushions, each of the two downwardly extending cushions shaped to correspond to the bedding receptacle of one of the first side and the second side of the case;
wherein, in the open position, each of the two downwardly extending cushions is positioned in one of the bedding receptacles of the case with the mattress top surface facing outward and away from the case, and,
wherein, in the closed position, the case is folded along the hinge axis such that the mattress assembly is folded into an interior of the case.

2. The bed according to claim 1, wherein, in the open position, the hinge axis is located proximate to a top of the sidewall of the first side of the case and proximate to a top of the sidewall of the second side of the case.

3. The bed according to claim 1, wherein the mattress assembly comprises a mattress cover having two sleeves on an underside thereof, each of the two sleeves configured to receive one of the two downwardly extending cushions.

4. The bed according to claim 1, wherein the mattress assembly defines a seam coaxial with the hinge axis such that the mattress assembly may be folded about the seam and the hinge axis.

5. The bed according to claim 1, wherein the mattress assembly comprises a padded bolster positioned on a periphery of the top surface of the mattress assembly.

6. The bed according to claim 3, wherein the mattress cover comprises a padded bolster positioned on a periphery of the top surface of the mattress assembly.

7. The bed according to claim 1, wherein, in the closed position, the sidewall of the first side of the case, the sidewall of the second side of the case, and the top surface of the mattress assembly define an interior volume therebetween.

8. The bed according to claim 1, further comprising a zipper extending at least partially around a periphery of the sidewalls of the first side and the second side of the case, wherein a portion of the zipper disposed on the first side of the case is configured to mate with a portion of the zipper disposed on the second side of the case to secure the first side of the case to the second side of the case in the closed position.

9. The bed according to claim 1, further comprising at least one fastener for connecting the mattress assembly to the case.

10. The bed according to claim 1, wherein the hinge of the case comprises:
a first portion connected to the sidewall of the first side of the case;
a second portion connected to the sidewall of the second side of the case; and
a flexible portion defining the hinge axis between the first portion and the second portion.

11. The bed according to claim 10, wherein the first portion of the hinge is connected to an outer face of the sidewall of the first side of the case; and
wherein the second portion of the hinge is connected to an outer face of the sidewall of the second side of the case.

12. The bed according to claim 10, wherein the hinge comprises a flexible fabric.

13. The bed according to claim 10, wherein, in the open position, the first portion of the hinge defines an acute angle relative to the second portion of the hinge.

14. The bed according to claim 1, further comprising a handle connected to at least one of the first side of the case and the second side of the case.

15. The bed according to claim 14, wherein the handle is located on a portion of the case opposite the hinge in the closed position.

16. A case for a bed foldable between an open position and a closed position, the case comprising:
a first side and a second side, each side having at least one sidewall defining a bedding receptacle, wherein the sidewall of the first side and the sidewall of the second side are connected via a hinge having a hinge axis located at a position between the sidewall of the first side and the sidewall of the second side, such that, in the open position, an outer surface of the sidewall of the first side faces an outer surface of the sidewall of the second side; and
wherein, in the open position, each of the bedding receptacles is opened facing upward and away from the case, and,
wherein, in the closed position, the case is folded along the hinge axis such that the sidewalls of the first side and the second side are aligned.

17. The case according to claim 16, wherein, in the open position, the hinge axis is located proximate to a top of the sidewall of the first side and proximate to a top of the sidewall of the second side.

18. The case according to claim 16, wherein the hinge comprises:
a first portion connected to the sidewall of the first side;
a second portion connected to the sidewall of the second side; and
a flexible portion defining the hinge axis between the first portion and the second portion.

19. The case according to claim 18, wherein the first portion of the hinge is connected to an outer face of the sidewall of the first side; and
wherein the second portion of the hinge is connected to an outer face of the sidewall of the second side.

20. The case according to claim 16, wherein the hinge comprises a flexible fabric.
